(19) United States
(12) Patent Application Publication
(10) Pub. No.: US 2023/0400442 A1
(43) Pub. Date: Dec. 14, 2023

(54) TITRATION METHODS FOR DETECTING POLYVINYL SULFONATE (PVS) IN BUFFERS

(71) Applicant: AMGEN INC., Thousand Oaks, CA (US)

(72) Inventor: Robert Joseph Soto, Thousand Oaks, CA (US)

(21) Appl. No.: 18/031,637

(22) PCT Filed: Oct. 15, 2021
(86) PCT No.: PCT/US21/55116

§ 371 Date: Apr. 13, 2023

Related U.S. Application Data
(60) Provisional application No. 63/251,465, filed on Oct. 1, 2021.
(60) Provisional application No. 63/144,744, filed on Feb. 2, 2021.
(60) Provisional application No. 63/093,124, filed on Oct. 16, 2020.

(51) Int. Cl. G01N 31/16; G01N 21/79

(52) U.S. Cl. CPC G01N 31/162; G01N 21/79

(57) ABSTRACT

The disclosure provides methods, including automated methods, to detect levels of polyanions such as polyvinyl sulfonates in fluids such as buffers by complexometric or titration-based techniques. Such polyanionic compounds have been shown to inhibit enzymes involved in PCR that confounds efforts to monitor the purity of proteins obtained from cell culture, such as biologies and biosimilars.

### CROSS-REFERENCE TO RELATED APPLICATIONS

This application claims priority to U.S. Provisional Patent Application No. 63/093,124, filed Oct. 16, 2020, U.S. Provisional Patent Application No. 63/144,744, filed Feb. 2, 2021 and U.S. Provisional Patent Application No. 63/251,465, filed Oct. 1, 2021, which are hereby incorporated by reference in their entirety.

### FIELD

The disclosure relates generally to the field of chemistry and more specifically to the field of determining, or titrating, the concentration of compounds in fluids.

### BACKGROUND

Biologics and biosimilars have become significant therapeutic classes for the treatment of human and other animal diseases and conditions. These products, which include recombinant proteins such as antibodies of various forms and fragments thereof that retain binding capacity, are typically obtained from cell culture. As a result, these therapeutics must be purified from contaminating substances inherent in cell culture processes, such as unneeded and potentially toxic proteins, lipids, carbohydrates and other small molecules associated with cells growing in culture. As the therapeutic biologics and biosimilars are progressively purified by separation from these culture contaminants, the therapeutics are stabilized in buffered solution. As purification progresses, moreover, the level of purity must be monitored to ensure that the therapeutic remains safe for use. One significant contaminant found when purifying therapeutics from cell cultures are fragments of host cell DNA. Residual amounts of host cell DNA can survive rigorous purification processes, remaining as a deleterious contaminant of the purified therapeutic. Residual host cell DNA contained in a formulation of the protein, such as a biologic or biosimilar, to be administered to an animal such as a human patient could elicit an undesirable immune response or increase the risk of cancer. As a consequence, governments have imposed limits on the concentration of host cell DNA contained in a formulation for administration to a human. The World Health Organization (WHO) and the European Union (EU), for example, allow the amounts for up to 10 ng/dose of residual host cell DNA, while the U.S. Food and Drug Administration allows no more than 100 pg/dose.

Given the low levels of host cell DNA permitted in therapeutic formulations intended for administration to humans, sensitive and accurate methods for determining the levels of host cell DNA in such formulations are needed. One approach to quantitating low levels of nucleic acids in samples is through use of the polymerase chain reaction, such as by monitoring nucleic acid levels in real time using qPCR. PCR is an enzyme-based technique that relies on enzymatic polymerases to amplify low levels of nucleic acids to facilitate their detection.

### SUMMARY

The disclosure provides methods for determining, or titrating, the level of a polyanion in a sample, for example a sample comprising a Good's buffer such as MES. The sample comprises a Good's buffer (for example, a Good's buffer raw material or production lot), and may further comprise a therapeutic compound such as a biologic or a small molecule. An exemplary polyanion is polyvinyl sulfonate (i.e., PVS), which is often present in varying amounts in Good's buffers or in samples of biologics at various stages of harvest and purification. These polyanions, and particularly PVS, have been found to inhibit various enzymes, including RNA and/or DNA enzymes such as polymerases. Disclosed herein are methods for detecting PVS levels in samples. The samples may comprise proteins such as biologics or may comprise other therapeutic compounds, e.g., small molecule therapeutics, or both, at varying stages of production, harvest, or purification. Methods known in the art have been incapable of detecting the low levels of PVS in such samples, leading to PVS contamination of therapeutic compounds such as biologics. Such contamination can prevent authorization for use in humans and the inhibitory effects of PVS confound efforts to monitor other impurities in product preparations, such as host nucleic acids. Polyanions like PVS inhibit enzymes used in standard nucleic acid assays such as PCR, e.g., qPCR, leading to inaccurate measures of contaminating host nucleic acids. Disclosed herein is a sensitive, accurate and precise method for measuring levels of PVS, a known inhibitor of RNA enzymes, in samples comprising Good's buffer (such as protein samples) by titration. The titration methods according to the disclosure exhibit a dynamic detection range of 1.5 orders of magnitude, are highly selective for PVS relative to MES, result in a simple readout with an inflection or equivalence point providing a straightforward pass/fail output for MES buffer lots under consideration for use in monitoring host cell nucleic acid contamination of protein samples such as biologic samples. The method also lends itself to automated electrochemical or spectroscopic (e.g., colorimetric, photometric, fluorometric, Raman, or FTIR spectroscopy) endpoint detection probes at reasonable cost as well as inexpensive embodiments reliant on standard manual titration arrangements.

In greater detail, the disclosure is drawn to a titration method for detecting a polyanionic enzyme inhibitor in a fluid comprising: (a) contacting a fluid with a known quantity of a polycationic compound; (b) contacting the material in (a) with an indicator compound, wherein the indicator compound exhibits a changed property in the free form compared to its form when complexed to a polycationic compound, and wherein sufficient indicator compound is added to detect the free form of the indicator compound in the absence of complex formation; (c) repeating (a); and (d) detecting the free form of the indicator compound at the titration point, thereby detecting the polyanionic enzyme inhibitor. The indicator compound may comprise or consist of an anionic indicator, including but not limited to a polyanionic indicator compound. In some embodiments, the fluid comprises, consists essentially of, or consists of a buffer. It is contemplated that (b) adding the indicator compound to the fluid may be performed prior to, concurrent with, or subsequent to the first iteration of (a), though it will be appreciated that in the case of subsequently added indicator compound, the indicator compound would be added before (a) is repeated. In some embodiments, a plurality of samples of the buffer are prepared, wherein each buffer sample has a different concentration of a buffering compound, thereby creating a dilution series of the buffer. In some embodiments, the limit of detection of polyvinyl sulfonate (PVS) is 1.5 parts per million of buffering solution, 0.25 parts per million of buffering solution, or 0.16 μg/mL of buffering solution. In some embodiments, the limit of detection of polyvinyl sulfonate (PVS) is 1.5 parts per million of buffering compound, or 0.25 parts per million of buffering compound. For example, automated methods as described herein can identify PVS at a limit of detection of 0.25 parts per million of buffering compound. In some embodiments, the titration end point is the point where the sample absorbance is halfway between the initial sample absorbance and the steady-state absorbance, or is a local maximum of the first derivative of the sample absorbance curve. In some embodiments, free indicator compound is detected electrochemically or spectroscopically. In some embodiments, the detection by spectroscopy comprises colorimetric detection, photometric detection, fluorometric detection, Raman, or FTIR spectroscopy. In some embodiments, the polyanionic enzyme inhibitor is polyvinyl sulfonate (PVS) or a derivative thereof. In some embodiments, the polyanionic enzyme inhibitor is polyvinyl sulfonate (PVS). In some embodiments, the polycationic compound is a pH-independent polycationic compound or a pH-dependent polycationic compound. In some embodiments, the pH-independent polycationic compound is a quaternary ammonium-based polymer. In some embodiments, the pH-dependent polycationic compound is a polyamine. In some embodiments, the quaternary ammonium-based polymer is hexadimethrine bromide (HDBr), poly(diallyl)dimethylammonium chloride (pDADMAC), or methylglycol chitosan. In some embodiments, the quaternary ammonium-based polymer is hexadimethrine bromide (HDBr). In some embodiments, a plurality of HDBr aliquots totaling at least 0.1% of a total fluid volume are added to the fluid. In some embodiments, the quaternary ammonium-based polymer is poly(diallyl)dimethylammonium chloride (pDADMAC).

A number of suitable indicators compounds, such as anionic indicators, may be used in embodiments herein. In some embodiments, the indicator compound is a dye, such as an azo dye. In some embodiments, the azo dye is Eriochrome Black T (ECBT), Eriochrome Blue Black R (Calcon) or Sulfonazo sodium salt. In some embodiments, the azo dye is Eriochrome Black T (ECBT). In some embodiments, 0.8-1.7 μg ECBT is added per mL of the fluid comprising a known quantity of the polycationic compound. In some embodiments, the buffer is a Good's buffer. In some embodiments, the Good's buffer comprises an ethane sulfonic acid derivative or a propane sulfonic acid derivative. In some embodiments, the Good's buffer is MES, Bis-tris methane, ADA, Bis-tris propane, PIPES, ACES, MOPSO, Cholamine chloride, MOPS, BES, AMPB, HEPES, DIPSO, MOBS, Acetamidoglycine, TAPSO, TEA, POPSO, HEPPSO, EPS, HEPPS, Tricine, Tris, Glycinamide, Glycylglycine, HEPBS, Bicine, TAPS, AMPB, CHES, CAPSO, AMP, CAPS, or CABS. Some embodiments of the methods further comprise determining the concentration of the polyanionic enzyme inhibitor from the quantity of polycationic compound required to titrate the polyanionic enzyme inhibitor. Some embodiments of the methods further comprise comparison of the results to results obtained with a standard curve of the polyanionic enzyme inhibitor, thereby determining the concentration of the polyanionic enzyme inhibitor in the fluid. For example, the endpoint volume may be calculated for a set of multiple polyanion (e.g., PVS) calibration standards (e.g., 3 to 5 standards), and a standard curve may be generated. The standard curve may be used to calculate the concentration of the polyanion in a sample based on the endpoint value of the sample. Some embodiments of the methods further comprise performing a “limit test”, in which the endpoint volume is calculated for a blank (containing no polyanion such as PVS) and a sample containing a concentration of polyanion (e.g., PVS) at a specified limit. The endpoint volume of the sample may be determined, and a “pass/fail” analytical determination made based on whether or not the concentration of the polyanion in the sample is within the specified limit. In some embodiments, the method is automated.

Another aspect of the disclosure is directed to an automated titration method for detecting a polyanionic enzyme inhibitor in a fluid comprising: (a) combining a fluid and an indicator compound, wherein the indicator compound exhibits a changed property in the free form compared to its form when complexed to a polycationic compound, and wherein sufficient indicator compound is added to detect the free form of the indicator compound in the absence of complex formation; (b) contacting the material in (a) with a known quantity of a polycationic compound; (c) measuring the absorbance of the fluid comprising the indicator compound and polycationic compound using a titrator instrument; and (d) automatically repeating (b) and (c), wherein detection of the free form of the indicator compound detects the polyanionic enzyme inhibitor. It is contemplated that (a) combining the fluid comprising a polycationic compound and an indicator compound may be performed prior to, concurrent with, or subsequent to the first iteration of (b), though it will be appreciated that in the case of subsequently combined indicator compound, the indicator compound would be added before (b) is repeated. In some embodiments, the fluid comprises, consists essentially of, or consists of a buffer. In some embodiments, the buffer is a Good's buffer. In some embodiments, the method is performed on a titrator instrument. In some embodiments, the titrator instrument comprises a pump such as a syringe pump or an intelligent dosing drive in fluid communication with the polycationic compound and the fluid. A suitable absorbance wavelength for the methods and systems described herein may be selected based on the indicator compound used. For example, for ECBT indicator compound, a wavelength of 660-665 nm is suitable.

Some aspects include an automated titration system for detecting a polyanionic enzyme inhibitor in a fluid. The automated titration system can comprise a fluid delivery system such as a pump. The automated titration system can be configured to automatically perform a method as described herein. By way of example, the automated titration system can comprise a titrator. For example, titrators suitable for methods and systems described herein are commercially available under Metrohm's TITRANDO line of instruments. Optionally the titrator may comprise a pump for fluid communication (for example to place the polycationic compound in fluid communication with the fluid), such as a syringe pump or an intelligent dosing drive pump.

Other features and advantages of the disclosure will become apparent from the following detailed description, including the drawing. It should be understood, however, that the detailed description and the specific examples, while indicating embodiments, are provided for illustration only, because various changes and modifications within the spirit and scope of the disclosure will become apparent to those skilled in the art from the detailed description.

### BRIEF DESCRIPTION OF THE DRAWINGS

FIG. 1. (a) Chemical structure of 2-(N-morpholino)-ethanesulfonic acid (i.e., MES) shown as the acidic form, MES hydrate, and as the basic form, MES sodium salt. (b) Chemical reactions leading to compounds capable of inhibiting enzymes active on nucleic acids, such as RNA enzymes. FIG. 1(b) is adapted from a figure in Smith, et al. J. Biol. Chem. 278:20934-20938 (2003).

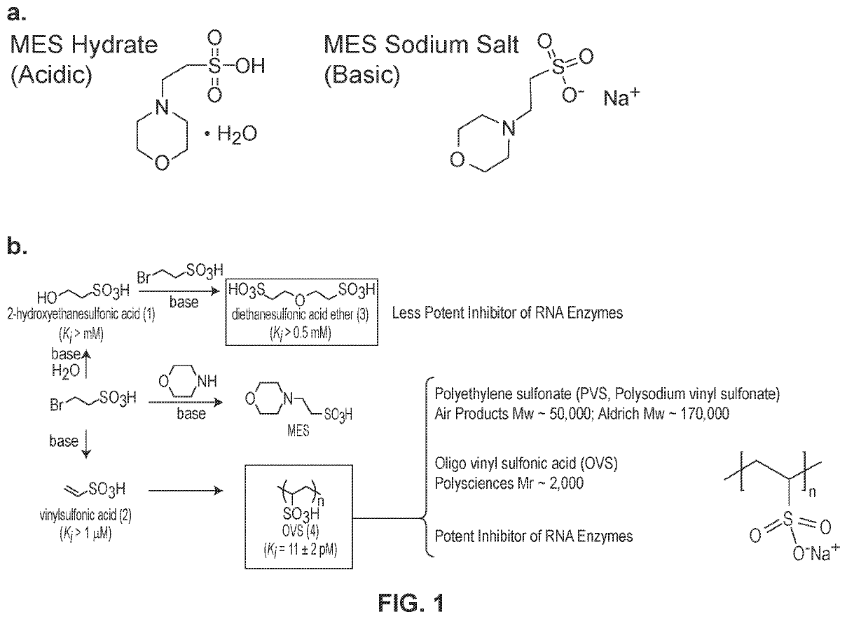

FIG. 2. (a) Varying the concentration of polyvinyl sulfonate (PVS) between 0-1.0 ppm revealed a linear calibration curve for two different lots of PVS standards obtained from Sigma-Aldrich, which were provided as 30 wt % aqueous solutions. The concentration of PVS was found to vary significantly lot-to-lot. It is contemplated, however, that the concentration of a particular lot can be adjusted by dilution to serve as a suitable standard. (b) Titration curves using hexadimethrine bromide (HDBr) to titrate PVS were constructed across the range of PVS concentrations of 0-1.0 ppm. A linear range of about 1.5 orders of magnitude was found.

FIG. 3. (a) Schematic for quantitation by titration of PVS with HDBr with spectroscopic endpoint detection. The reaction scheme depicts complexation between PVS and HDBr driven by attractive electrostatic interactions. At the endpoint of the titration, an indicator compound (nD⁻) undergoes a change in absorbance properties upon association with neighboring HDBr charge sites. The blue circular “plus” and “minus” symbols in FIG. 3(a) refer to background salts in solution. (b) The plot shows the evolution of the solution absorbance for a blank sample (i.e., 50 mM borate buffer, pH 8.5, supplemented with EBT indicator compound), measured on a benchtop absorbance spectrometer, as HDBr is incrementally titrated into solution. With increasing HDBr concentration, the indicator absorbance at 665 nm decreases with a concomitant shift in the absorbance maximum from about 630 to 593 nm.

FIG. 4. Titration curves plotting the normalized, volume-corrected absorbance at 665 nm for a series of PVS standard solutions.

FIG. 5. (a) Plot of the volume-corrected solution absorbance at 665 nm against the HDBr (titrant) mass for three different PVS standards prepared in MES matrix blank. (b) A comparison of the titration curve inflection points between PVS standards prepared in 50 mM sodium borate (green triangles) and MES mixed with 50 mM sodium borate (black squares).

FIG. 6. A comparison of the titration curve inflection points for PVS standards prepared in MES matrix blank (black squares), a negative control lot of MES (blue diamond), and an MES lot that caused qPCR invalid assays (Lot #I; red circle).

FIG. 7. Representative profile for titration of a blank standard (100 mM carbonate buffer supplemented with 1.25 μg/mL EBT indicator) with 0.04 mg/mL HDBr (black trace) and the corresponding first derivative (red trace).

FIG. 8. (a) Plot of titration endpoint volume versus the concentration of PVS spiked into 50 mM MES dissolved in 100 mM carbonate buffer. (b) Plot of titration endpoint volume versus the concentration of PVS for standard samples prepared in 100 mM carbonate buffer.

FIG. 9. Representative titration curves for (A,B) PVS standard solutions prepared at 0 (A) or 0.75 (B) μg/mL in 100 mM carbonate buffer; and (C,D) PVS spiked at 0 (C) or 0.70 (D) μg/mL into 50 mM MES (sample H in Table 2) prepared in 100 mM carbonate buffer.

FIG. 10. Provides plots of titration endpoint volume versus concentration of PVS. A) is a plot of titration endpoint volume versus the concentration of PVS for standard samples prepared in 100 mM carbonate buffer. B) is a plot of titration endpoint volume versus the concentration of PVS spiked into 50 mM MES sodium salt dissolved in 100 mM carbonate buffer.

### DETAILED DESCRIPTION

Polyanionic compounds such as poly(vinylsulfonate) (PVS) are polymeric impurities in Good's buffers such as MES buffer. These polyanionic compounds, e.g., PVS, are present in such buffers at low levels in the range of parts per million relative to the buffering compound such as MES. The presence of these impurities in Good's buffers is a significant concern because such buffers are used in the manufacture of therapeutic proteins, and these impurities, and in particular PVS, are potent polymerase inhibitors that can interfere with quantitative PCR (qPCR) detection of DNA. Measures of host cell nucleic acids (e.g., DNA) in formulations of therapeutic proteins purified from culture, or in formulations of other therapeutic compounds, are routinely required to assess the safety of therapeutics intended for administration to humans. A significant challenge in using PCR-based techniques to detect and quantitate host cell nucleic acid in therapeutic formulations is the presence of nucleic acid enzyme inhibitors in many of the buffers (e.g., Good's buffers) used in purifying proteins, such as biologics and biosimilars, from cell cultures. The speed, accuracy and reproducibility of PCR-based methods of detecting and quantitating levels of host cell nucleic acids in these formulations has led to a significant need in the art to identify and remove inhibitors of the nucleic acid enzymes, e.g., RNA enzymes, involved in PCR. Thus, the presence of polyanionic compounds such as PVS in Good's buffers such as MES can cause batches of therapeutic protein(s) or other therapeutic compound(s) to fail acceptance criteria for human administration by interfering with qPCR detection of host cell DNA.

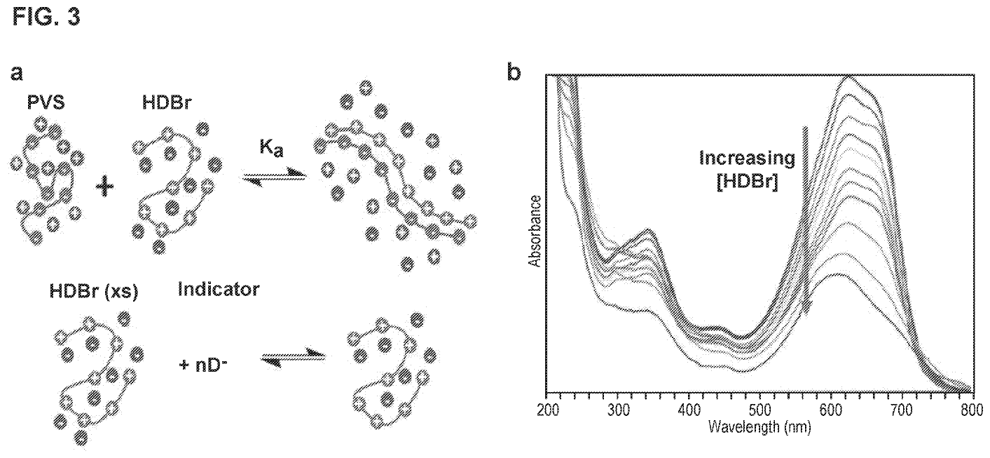

Disclosed herein are methods involving titration based on complexation of the analyte (e.g., PVS) with an oppositely charged, high molecular weight titrant. This interaction results in an exceedingly high equilibrium association constant (Kₐ) and the endpoint can be detected electrochemically or spectroscopically (e.g., colorimetric, photometric, fluorometric, Raman, or FTIR spectroscopy). A summary of the detection scheme, applied to the titration of PVS with hexadimethrine bromide (HDBr), an exemplary titrant, is provided in FIG. 3.

Nine lots of commercial MES buffer were obtained and subjected to analysis using the titration method for detecting and measuring PVS disclosed herein. Comparative assessments of these lots of MES buffer were performed using the disclosed titration method of detecting and measuring PVS and using qPCR. As the experimental data shows, the method is capable of sensitive detection of low levels of PVS and accurately and precisely detects lot-to-lot variation in PVS levels. Such analyses revealed a commercial lot of MES buffer (Lot #I) containing a markedly high level of PVS, consistent with observations of lot-to-lot variability in buffer-associated inhibition of host cell nucleic acid contamination of biologic samples using PCR (e.g., qPCR).

The data provided in the following examples establish that the titration method of detecting and measuring PVS in samples using a polycationic compound such as hexadimethrine bromide (i.e., HDBr) is highly selective for PVS over MES, with a K_{a, PVS}>>K_{a, MES}, where Kₐ represents the equilibrium association constant for the complexation reaction between the titrant (HDBr) and either PVS (K_{a, PVS}) or MES (K_{a, MES}). The results disclosed herein reveal that the disclosed titration method is repeatable (precise) and capable of detecting low levels of polyanions, e.g., PVS, in Good's buffers such as MES, with a limit of quantitation (i.e., LOQ) of about 100-200 ng/mL.

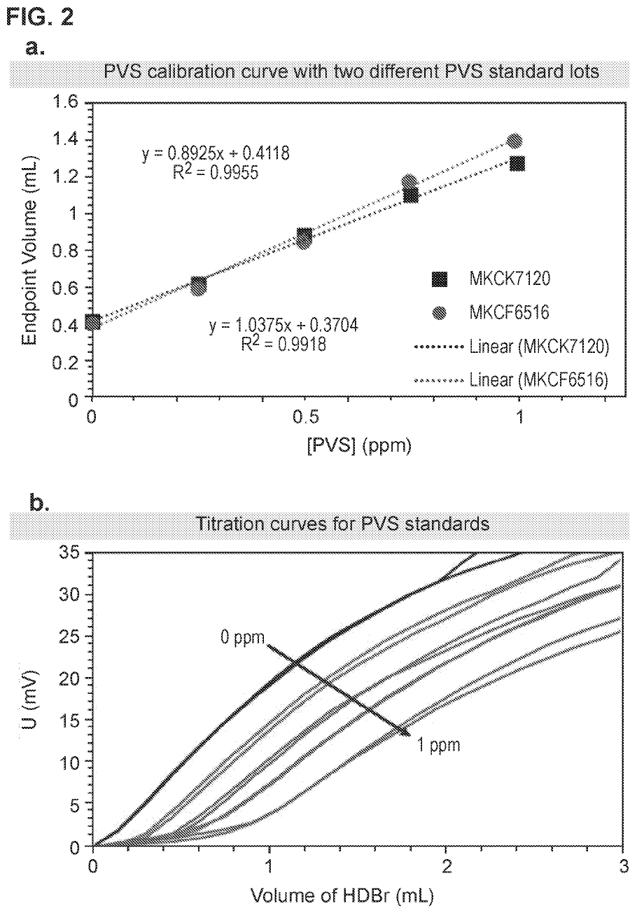

The protocol disclosed herein describes a polyelectrolyte titration approach to quantitating polyanions such as poly(vinylsulfonate) (PVS) in Good's buffers such as 2-(N-morpholino)-ethanesulfonic acid (MES) buffer. The methodology is extendable to other Good's buffers (e.g., HEPES) produced from vinylsulfonic acid. The underlying mechanism for PVS detection is based on binding with a polycationic species, hexadimethrine bromide (HDBr). A schematic of the binding reaction is provided in FIG. 3a. This approach exploits the high equilibrium association constant (Ka) between PVS and HDBr for selectivity over MES, a monoanion. Indeed, the Ka between a polycation and polyanion increases steeply with the number of charge sites (positively correlated to polymer molecular weight). At the endpoint of the titration, excess HDBr associates with the anionic indicator compound, Eriochrome Black T (ECBT), producing a shift in the UV-Vis absorbance profile of the indicator (FIG. 3b). The progression of the titration can be tracked at a single wavelength (i.e., 665 nm) and related to the concentration of PVS in the sample by, for example, calculating the inflection point of the resulting sigmoidal curve, as shown in FIG. 2.

### EXAMPLES

### Example 1

### Materials and Methods

Approximately 30 wt % poly(vinylsulfonic acid) (PVS) sodium salt was purchased from Sigma-Aldrich (#278424) and Alfa Chemistry (#ACM25053274) and was diluted to prepare PVS standards of known concentration ranging from 0.1 to 20 μg/mL. 50 mM borate buffer (pH 8.5) was prepared using conventional techniques. 100 mM carbonate buffer (pH 10.0) was prepared from sodium carbonate (Sigma-Aldrich #223484) and sodium bicarbonate (Sigma-Aldrich #S6014). The carbonate and bicarbonate buffers were supplemented with about 0.1 mM ethylenediaminetetraacetic acid (EDTA; MP Biomedicals #06133713). 1,5-dimethyl-1,5-diazaundecamethylene polymethobromide (Hexadimethrine bromide; HDBr) was purchased from Sigma-Aldrich (107689) and Carbosynth (#FH165280). Eriochrome Black T (EBT or ECBT) was purchased from Sigma-Aldrich (#858390). All solutions were prepared using water that had been purified to a minimum resistivity of 18 MΩ-cm. A 100 mM solution of MES hydrate was cleared of PVS by filtration over a 0.2 μm Posidyne® filter (2.8 cm² surface area) and served as the sample blank for Example 1.

Assay buffers prepared in a manner consistent with the procedure described above yielded Buffer A comprising 50 mM sodium borate, with pH adjusted to 8.5 with hydrochloric acid, and Buffer B comprising 100 mM combined sodium carbonate and bicarbonate, formulated to produce a solution of pH 10.0. The indicator compound or dye solution, e.g., Eriochrome Black T (ECBT; 55 wt %), served as the indicator compound. When the indicator compound was ECBT, a solid aliquot of this material was stored at room temperature. To prepare an exemplary ECBT dye solution, 125 mg of ECBT was added to a 25 mL volumetric flask and the actual mass was recorded. The ECBT was dissolved in 25 mL de-ionized (i.e., DI) water and stored as 1 mL aliquots in 1.6 mL polypropylene microcentrifuge tubes at 2-8° C. until use. The polycationic compound of the disclosed methods is a titrant, and an exemplary titrant solution was made using HDBr. This material was stored at 2-8° C. To prepare the solution, 18.7 mg HDBr was weighed directly into a glass vial and dissolved in 3.74 mL water to yield a 5 mg/mL stock solution. 0.05 μg/mL HDBr titrants were then prepared by 1:20 or 1:100 dilution, respectively, of the 5 mg/mL HDBr solution in 50 mM borate buffer supplemented with 0.1 mM EDTA. This solution was used as the titrant solution for the assay methods disclosed herein. The HDBr titrant solutions were prepared as 10 mL solutions in 15 mL polypropylene centrifuge tubes and stored at 2-8° C.

Standard Preparation

A commercial poly(vinylsulfonate) (PVS) stock solution was used to prepare the assay standards (Alfa Chemistry, 25 wt %, sodium-salt, Lot #Al9X05191) by performing serial dilutions of the stock solution in water. The PVS solutions in Table 1 were then spiked into 50 mM borate buffer (supplemented with 0.1 mg/mL EDTA) to prepare standards of known PVS concentration.

TABLE 1

| PVS Stock | V_{water} | V_{Standard} | Dilution | Approximate |
|---|---|---|---|---|
| Dilution Factor | (mL) | (mL) | Used | [PVS] (μg/mL) |
| 1:20 | 0.950 | 0.050 | Stock | 12500 |
| 1:400 | 0.950 | 0.050 | 1:20 | 625 |
| 1:2000 | 0.800 | 0.200 | 1:400 | 125 |
| 1:10000 | 0.800 | 0.200 | 1:2000 | 25 |

Stocks and standard solutions were stored at 2-8° C.

Sample Preparation

100 mM solutions of MES hydrate (Lot #s I and II), pH adjusted to 7.00±0.05 were prepared as follows. 2.132 g MES hydrate were dissolved in 95 mL water, the pH was adjusted using aqueous NaOH, and the solution was thereafter adjusted to a final volume of 100 mL with water. The pH was measured using a conventional pH meter. Solutions were stored at 2-8° C.

Assay Procedure

Although titration feasibility experiments were carried out using a simple protocol described below, such experiments could be automated by using a photometric titrator instrument to automate the steps described herein. UV and visible lamps of the spectrometer were warmed for at least 20 minutes prior to use by turning on the spectrometer. The spectrometer was blanked before each assay using either the standard or sample solutions. The standard cell used in the disclosed assay was a 10 mm, 1.5 mL quartz cuvette. The standard consists of PVS diluted in assay buffer. The sample is prepared by mixing 100 mM MES as an exemplary Good's buffer with assay buffer. This step is performed because the exemplary ECBT indicator compound undergoes a color change over pH values of 6-7, whereas pH values greater than 7 are above the buffer region for MES. Therefore, MES was mixed with basic buffers, i.e., A or B, as described above, to ensure that the ECBT indicator was deprotonated.

Initial experiments mixed Buffer A and MES in a 1:1 ratio. It is expected that more basic buffers (e.g., B and C), mixed with MES in different volumetric ratios, will increase assay performance.

Once the spectrometer was blanked, a small volume of the ECBT solution was added to the standard/sample. Initially, 995 μL standard/sample were mixed with 5 μL ECBT (5 mg/mL), yielding a final ECBT concentration of 25 μg/mL. Full wavelength absorbance scans were acquired. The standard/sample solution was titrated by adding small volumes (10-100 μL) of the 0.050 mg/mL HDBr solution to the cuvette, measuring the sample absorbance between each HDBr addition. A 200 μL pipette was used to mix the solution and the solution was allowed to stand for about 1 minute before measuring absorbance. The volume of HDBr was gradually increased over the course of the titration. For instance, small-volume (e.g., 10 μL) additions were initially performed, as the absorbance profile changed drastically early in the titration. Larger volumes were added later in the titration when the absorbance change was more significantly affected by dilution.

In some instances (e.g., for solutions with larger PVS concentrations), a more concentrated 0.25 mg/mL HDBr solution was used. The preceding steps of blanking the spectrophotometer and adding a small volume of the dye solution to the standard/sample were then repeated for each sample.

Data Analysis.

From UV-vis spectra, absorbance was plotted at 665 nm against the mass of HDBr added (in μg). The absorbance should be corrected for the change in solution volume to account for dilution, which was achieved by multiplying A665 nm by the total solution volume (i.e., original volume of the solution [1.000 mL], plus the cumulative volume of titrant solution added).

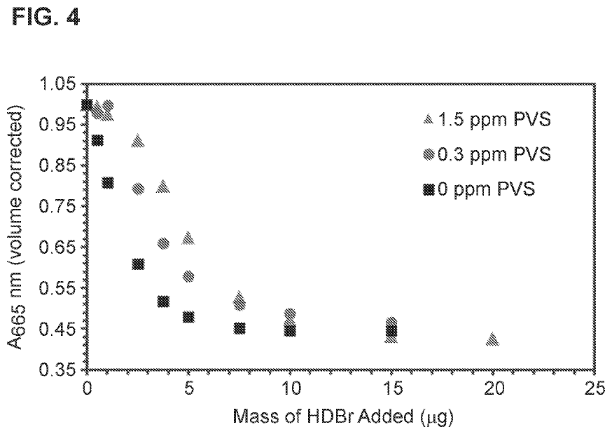

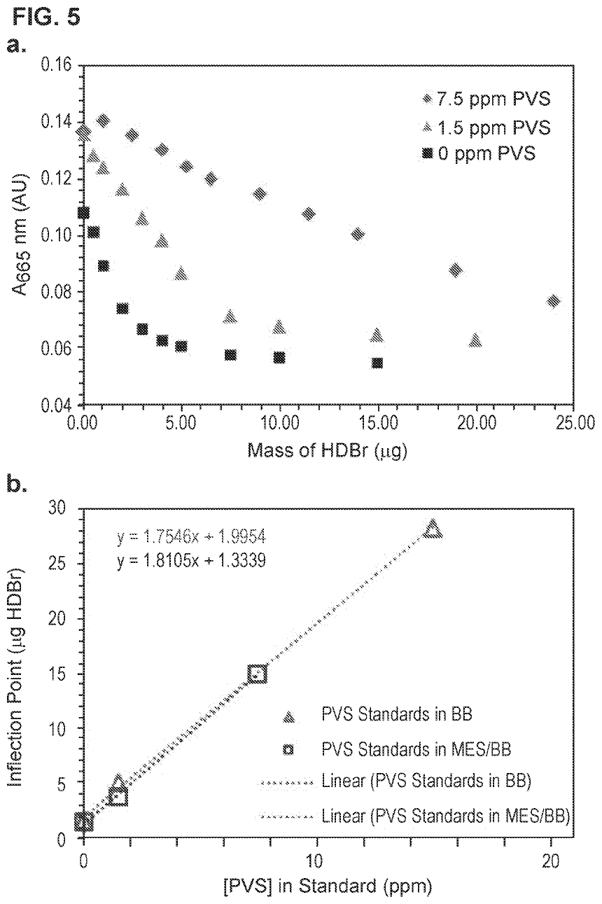

FIGS. 4 and 5 summarize the results of the assessment. FIG. 4 presents the volume-corrected solution absorbance at 665 nm with respect to the mass of HDBr titrant for assay buffer spiked at three different PVS levels.

FIG. 5a presents the volume-corrected solution absorbance at 665 nm with respect to the mass of HDBr titrant for MES matrix blank spiked at three different PVS levels. For both the 0 ppm PVS standard and the sample blank (i.e., MES blank), addition of titrant caused an initial decline in A₆₆₅, which stabilized after about 5.00 μg HDBr was added to the solution. The remaining PVS standards and samples, which were prepared by spiking commercially sourced PVS into solution, required a larger amount of titrant to reach steady-state absorbance. For example, the 7.5 ppm sample (FIG. 5a) achieved stable A₆₆₅ only after more than 40 μg HDBr was added. Taken together, these data indicated clear differences in the titration curves (FIGS. 4 and 5a) related to the quantity of PVS in the sample solution. FIG. 5b summarizes this relationship by plotting the calculated inflection point for PVS standard solutions prepared in 50 mM borate buffer (pH 8.5) (green triangle) or MES that had been spiked with PVS and subsequently mixed with 50 mM borate buffer (pH 8.5) to adjust the solution pH (black squares). The slopes for the two sets of data were comparable, indicating that the presence of MES at high concentration (100 mM) did not interfere with PVS quantitation. Furthermore, these data support detection of PVS at concentrations as low as 1.5 ppm (μg/mL) in 100 mM MES solution and 0.3 ppm in assay buffer.

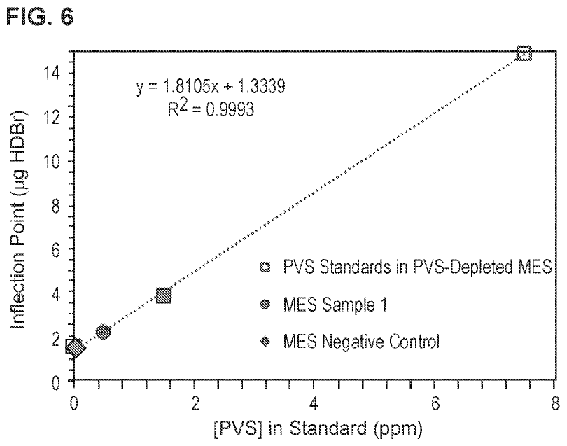

To further evaluate the performance of the titration procedure, two distinct lots of MES were evaluated alongside the PVS standards. A lot of MES hydrate (Sample 1) that resulted in invalid qPCR results for several products was compared to another MES sample that had a minimal amount of PVS per qPCR assay (i.e., the same material used to generate the sample blank in FIG. 5). The results for this assessment, shown in FIG. 6, showed a measurable amount of PVS present in MES sample 1, but not in the negative control MES material, which was indistinguishable from the PVS-depleted matrix blank. These results establish that the disclosed methodology can accurately identify MES hydrate materials with unsuitable levels of PVS. Moreover, MES hydrate materials without PVS, or with intermediate levels of PVS that would not interfere with qPCR, are distinguished from the unsuitable MES materials.

### Example 2

### Automated Titration

Automated titrations of the PVS standard and MES sample solutions were carried out using a Metrohm 907 Titrando instrument equipped with an intelligent dosing drive (#2.800.0010) and a dosing unit with a 20 mL volume capacity (#6.303.2200). 100 mL standard or sample solution was supplemented with 0.8-1.7 μg/mL EBT indicator (e.g., by spiking in 0.5-1.0 mg/mL EBT stock) immediately before titration. The resulting solution was assayed by monotonically titrating the sample with HDBr in 50-150 μL volume increments, with the signal from the photometric probe being allowed to stabilize between dosing increments. The titration progress was monitored by continuously measuring sample solution absorbance at 660 nm using an immersible photometric probe (Optrode, #6.1115.000), with the titration end point determined using the maximum dU/dV in the titration curve first derivative.

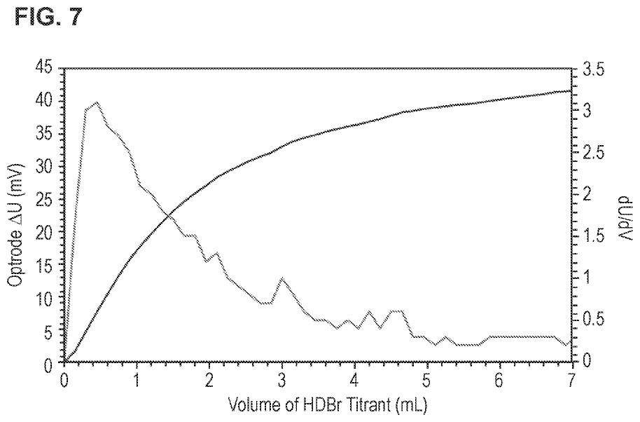

A representative titration profile for a blank standard is presented in FIG. 7 (black trace), alongside the corresponding first derivative (red trace). The volume at which the maximum in the first derivative occurs (i.e., V_{Titrant} of approximately 0.55 mL in FIG. 7) corresponds to the titrant end point and is used in the determination of PVS concentration.

The pH of the sample solution plays an important role in the measurement of PVS, either by impacting the anionic charge density on the PVS analyte or indirectly by protonation of the indicator compound to form the monovalent anion (H₂In⁻), which does not undergo a change in absorbance upon complexation with HDBr. The experiments, described above in Example 1, indicated that mixing prepared MES solutions with an alkaline buffer would be a viable approach for ensuring a suitable sample pH. Use of this approach in automated titration experiments (i.e., by dissolution of MES samples at 50 mM MES in 100 mM carbonate buffer) was verified through an assessment of PVS spike recovery in MES sample solutions. For this evaluation, 10 ppm PVS stock solution was spiked at varying concentrations into MES hydrate sample solutions (Sample H; see Table 2). This material, when assayed by titration without additional PVS spiked into the sample, produced end point volumes indistinguishable from the blank standard, indicating a PVS level below the method limit of detection.

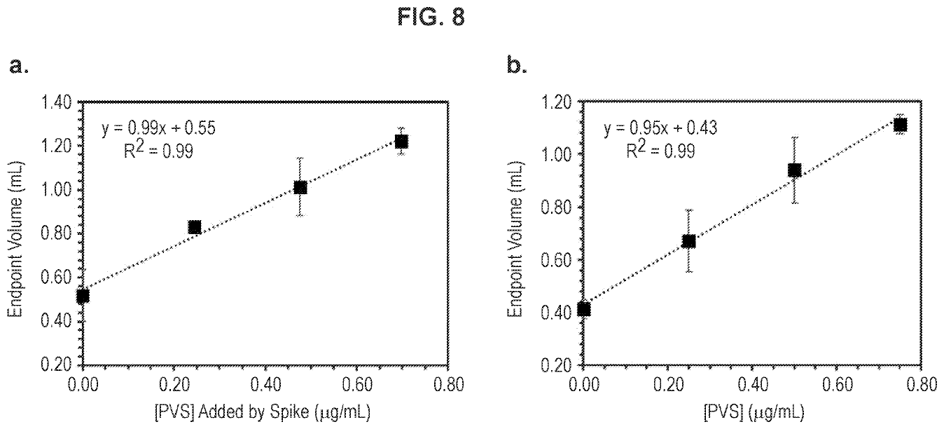

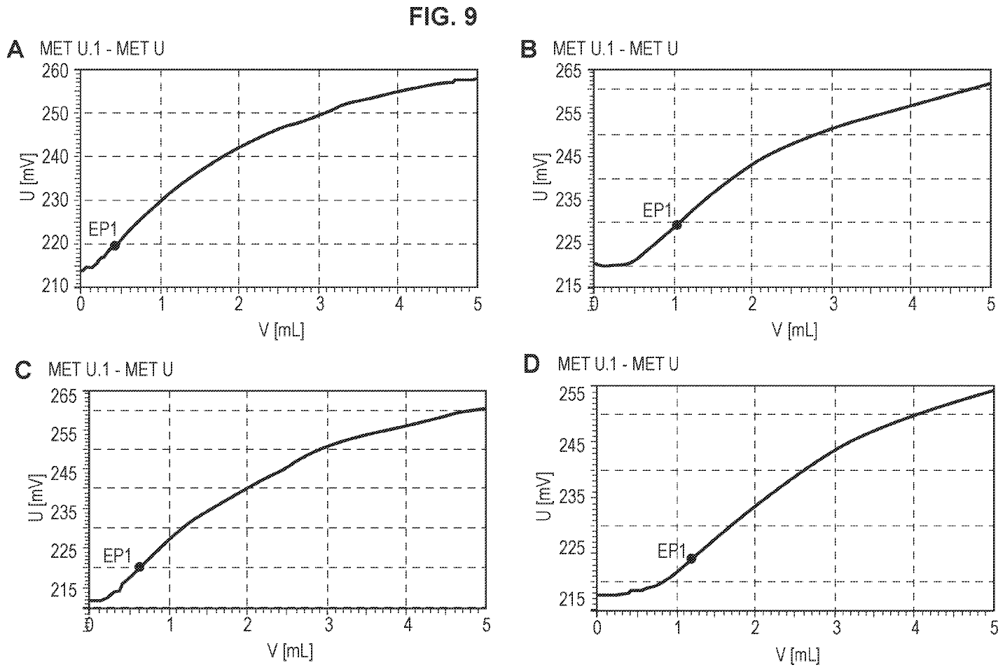

The results for the spike recovery assessment are presented in FIG. 8a, which plots the titration end point volume against the concentration of PVS at four different PVS levels (each assayed in triplicate). For comparison, results for PVS standards prepared in 100 mM carbonate buffer alone are shown in FIG. 8b. For both sets of data, linear regression between the titration end point volume and the PVS concentration resulted in similar slopes (0.99 and 0.95 mL/(μg/mL)) with appropriate linear coefficients of determination (R²=0.99). In addition, visual examination of the representative titration curves shown in FIG. 9 for the PVS standards (FIGS. 9A and 9B) and spike recovery samples (FIGS. 9C and 9D) showed no perceptible impact of the lower pH or the presence of 50 mM MES to the titration profile. Collectively, these results indicate no appreciable impact of the lower sample pH or the presence of 50 mM MES to measured PVS levels.

Over the course of development of the titration procedure, several MES hydrate lots were evaluated for PVS content by titration of 50 mM MES (dissolved in 100 mM carbonate buffer) with 0.10 mg/mL HDBr. The titration end points were compared to results generated for a series of PVS standard solutions. The results from these assessments are presented in Table 2. Among these samples was a lot of MES hydrate (Sample I) that caused failure of the qPCR assay for several therapeutic protein batches. Sample I had a PVS level, measured by titration, of 71±4 μg PVS per gram of MES hydrate, a value significantly greater than the PVS levels measured for any of the other samples tested, supporting the utility of the titration in screening MES materials with unsuitable levels of PVS. It is noted that for some MES hydrate lots, (i.e., E.1 and E.2, F.1 and F.2, and H.1 and H.2), different iterations of the titration procedure are shown. For example, E.1 represents an iteration based on a single replicate, and E.2 represents an iteration based on triplicate.

TABLE 2
MES hydrate samples evaluated for PVS during titration method development

| MES Hydrate | [PVS] in 100 mL 50 | [PVS], Dry Basis (μg |
|---|---|---|
| Lot Number | mM MES (μg/mL) | PVS/g MES Hydrate) |
| A^{a} | 0.21 ± 0.07 | 21 ± 7 |
| B^{a} | 0.38 ± 0.18 | 39 ± 19 |
| C^{a} | 0.26 ± 0.09 | 27 ± 9 |
| D^{b} | 0^{c} | 0^{c} |
| E.1^{b} | 0.14 | 14 |
| E.2^{a} | 0.28 ± 0.08 | 29 ± 8 |
| F.1^{b} | 0.25 | 25 |
| F.2^{a} | 0.23 ± 0.03 | 24 ± 3 |
| G^{b} | 0.04 | 4 |
| H.1^{b} | 0^{c} | 0^{c} |
| H.2^{a} | ≤0.16 | ≤16 |
| I^{a} | 0.71 ± 0.04 | 71 ± 4 |

^{a}Samples were evaluated in triplicate.
^{b}Samples were evaluated without replicate measurement.
^{c}Sample was below the LOD of 0.16 μg/mL (16 μg/g).

### Example 3

### Comparison of Detection Methods

Several methods for detecting and measuring polycations such as PVS in protein samples (e.g., biologic samples) were assessed. An ion coordination method involving induced aggregation of a polyionic reporter counterion by PVS with turbidimetric detection is a straightforward method of low complexity, but the method failed to reliably detect lots of MES buffer having high levels of PVS. A fluorescence based method involving direct detection of aqueous PVS via fluorescence excitation and detection was another straightforward method of low complexity, but the method proved infeasible for detection of PVS, as PVS in solution is not fluorescent, while the fluorescence associated with dried PVS samples was determined to be a PVS-nonspecific artifact associated with the dried sample. Another fluorescence-based method involved PVS-induced quenching of a fluorescent reporter molecule was more involved and did not show promise because of limited capacity to selectively detect PVS relative to MES. A method based on the physical characteristics of polyanions found in Good's buffers is size exclusion chromatography with charged-aerosol detection (i.e., SEC-CAD). This method was capable of detecting PVS in MES buffers, but the method is considerably more complex than the other methods. One more ion coordination method was assessed and that method, involving polyelectrolyte complexation and titration using ultraviolet-visible wavelength absorbance detection, was found to produce unexpectedly superior results in providing accurate, precise and sensitive detection and quantitation of PVS in Good's buffers, including but not limited to the Good's buffers provided in Table 3. This method, disclosed herein as the titration method, is a straightforward method of low complexity and cost in addition to providing the benefits of accuracy, precision and sensitivity.

TABLE 3
Good's buffers

| BUFFER | PK_{A} | BUFFER | PK_{A} |
|---|---|---|---|
| MES | 6.15 | POPSO | 7.85 |
| BIS-TRIS METHANE | 6.60 | HEPPSO | 7.9 |
| ADA | 6.62 | EPS | 8.0 |
| BIS-TRIS PROPANE | 6.80 | HEPPS | 8.1 |
| PIPES | 6.82 | TRICINE | 8.15 |
| ACES | 6.88 | TRIS | 8.2 |
| MOPSO | 6.95 | GLYCINAMIDE | 8.2 |
| CHOLAMINE CHLORIDE | 7.10 | GLYCYLGLYCINE | 8.2 |
| MOPS | 7.15 | HEPBS | 8.3 |
| BES | 7.17 | BICINE | 8.35 |
| AMPB | 8.8 | TAPS | 8.55 |
| HEPES | 7.55 | AMPB | 8.8 |
| DIPSO | 7.6 | CHES | 9.3 |
| MOBS | 7.6 | CAPSO | 9.6 |
| ACETAMIDOGLYCINE | 7.7 | AMP | 9.7 |
| TAPSO | 7.6 | CAPS | 10.4 |
| TEA | 7.8 | CABS | 10.7 |

### Example 4

### Quantitation of PVS in Prepared Aqueous Solutions of MES Sodium Salt

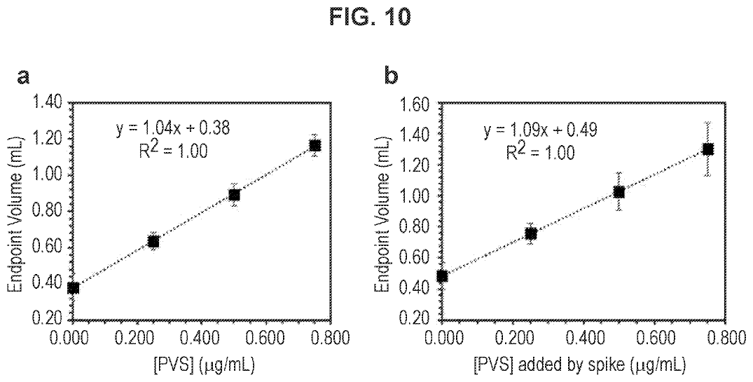

Aqueous solutions of MES sodium salt, which are considerably more alkaline than solutions of the MES hydrate conjugate acid (e.g., pH about 10.0 and about 8.5 for solutions of 50 mM MES sodium salt and MES hydrate in 100 mM carbonate buffer, respectively), are also amenable to PVS determination using a similar titration procedure to that presented in Example 2. FIG. 10(B) plots the titration endpoint, determined photometrically at 660 nm, for 50 mM MES sodium salt solutions prepared in 100 mM carbonate buffer and spiked with PVS standard. For comparison, FIG. 10(A) plots the titration endpoint volume as a function of PVS concentration for standards prepared in 100 mM carbonate buffer alone. For both sets of data, linear regression between the titration end point volume and the PVS concentration resulted in similar slopes (1.04 and 1.09 mL/(μg/mL)) with linear coefficients of determination (R²) of 1.00. Importantly, the magnitude of the spike recovery slopes for both MES hydrate and MES sodium salt samples were within the typical experimental error of the method (i.e., no appreciable difference in the analytical response between the two sample types).

Each cited patent or other publication is expressly incorporated herein by reference in its entirety or in relevant part as would be apparent to one of ordinary skill in the art from context, the incorporation effectively describing and disclosing, for example, the methodologies described in such publications that might be used in connection with information disclosed herein.

1. A titration method for detecting a polyanionic enzyme inhibitor in a fluid comprising:
(a) contacting a fluid with a known quantity of a polycationic compound;
(b) contacting the material in (a) with an indicator compound, wherein the indicator compound exhibits a changed property in the free form compared to its form when complexed to a polycationic compound, and wherein sufficient indicator compound is added to detect the free form of the indicator compound in the absence of complex formation;
(c) repeating (a); and
(d) detecting the free form of the indicator compound at the titration point, thereby detecting the polyanionic enzyme inhibitor.

2. The method of claim 1 wherein the fluid comprises or consists of a buffer.

3. The method of claim 2 wherein a plurality of samples of the buffer are prepared, wherein each buffer sample has a different concentration of a buffering compound, thereby creating a dilution series of the buffer.

4. The method of claim 1 wherein the limit of detection of polyvinyl sulfonate (PVS) is 1.5 parts per million of buffering solution, 0.25 parts per million of buffering solution, or 0.16 μg/mL of buffering solution.

5. The method of claim 1 wherein the titration end point is the point where the sample absorbance is halfway between the initial sample absorbance and the steady-state absorbance, or is a local maximum of the first derivative of the sample absorbance curve.

6. The method of claim 1 wherein free indicator compound is detected electrochemically or spectroscopically.

7. The method of claim 6 wherein the detection by spectroscopy comprises colorimetric detection, photometric detection, fluorometric detection, Raman, or FTIR spectroscopy.

8. The method of claim 1 wherein the polyanionic enzyme inhibitor is polyvinyl sulfonate (PVS) or a derivative thereof.

9. (canceled)

10. The method of claim 1 wherein the polycationic compound is a pH-independent polycationic compound or a pH-dependent polycationic compound.

11. The method of claim 10 wherein the pH-independent polycationic compound is a quaternary ammonium-based polymer or a polyamine.

12. (canceled)

13. The method of claim 11 wherein the quaternary ammonium-based polymer is hexadimethrine bromide (HDBr), poly(diallyl)dimethylammonium chloride (pDADMAC), or methylglycol chitosan.

14. (canceled)

15. The method of claim 13 wherein a plurality of HDBr aliquots totaling at least 0.1% of a total fluid volume are added to the fluid.

16. (canceled)

17. The method of claim 1 wherein the indicator compound is a dye.

18. The method of claim 17 wherein the dye is an azo dye.

19. The method of claim 18 wherein the azo dye is Eriochrome Black T (ECBT), Eriochrome Blue Black R (Calcon) or Sulfonazo sodium salt.

20. (canceled)

21. The method of claim 19 wherein the azo dye is ECBT and 0.8-1.7 μg ECBT is added per mL of the fluid comprising a known quantity of the polycationic compound.

22. The method of claim 2 wherein the buffer is a Good's buffer.

23. (canceled)

24. (canceled)

25. The method of claim 1 further comprising determining the concentration of the polyanionic enzyme inhibitor from the quantity of polycationic compound required to titrate the polyanionic enzyme inhibitor.

26. (canceled)

27. (canceled)

28. An automated titration method for detecting a polyanionic enzyme inhibitor in a fluid comprising:
(a) combining a fluid and an indicator compound, wherein the indicator compound exhibits a changed property in the free form compared to its form when complexed to a polycationic compound, and wherein sufficient indicator compound is added to detect the free form of the indicator compound in the absence of complex formation;
(b) contacting the material in (a) with a known quantity of a polycationic compound;
(c) measuring the absorbance of the fluid comprising the indicator compound and polycationic compound using a titrator instrument; and
(d) automatically repeating (b) and (c), wherein detection of the free form of the indicator compound detects the polyanionic enzyme inhibitor.

29. The method of claim 28 wherein the fluid comprises or consists of a buffer.

30. The method of claim 29 wherein the buffer is a Good's buffer.

31. The method of claim 30 wherein the titrator instrument comprises a pump such as a syringe pump or an intelligent dosing drive in fluid communication with the polycationic compound and the fluid.
